(19) United States
(12) Patent Application Publication
(10) Pub. No.: US 2012/0059833 A1
(43) Pub. Date: Mar. 8, 2012

(54) Prevention of library information leakage

(75) Inventor: Kazuhiro Matsuzaki, Kawasaki (JP)

(73) Assignee: FUJITSU LIMITED, Kawasaki-shi (JP)

(21) Appl. No.: 13/137,561

(22) Filed: Aug. 25, 2011

(30) Foreign Application Priority Data
Sep. 2, 2010 (JP) 2010-196577

(51) Int. Cl. G06F 17/30

(52) U.S. Cl. 707/758; 707/E17.039

(57) ABSTRACT

An apparatus for preventing library information leakage includes an input processing unit to register, in an input-item list, library information items included in input design data, an input-item-list storing unit to store the input-item list, and an output processing unit to include, in output design data, library information items that match the library information items registered in the input-item list.

### CROSS-REFERENCE TO RELATED APPLICATIONS

The present application is based upon and claims the benefit of priority from the prior Japanese Patent Application No. 2010-196577 filed on Sep. 2, 2010, with the Japanese Patent Office, the entire contents of which are incorporated herein by reference.

### FIELD

The disclosures herein relate to a library information leakage preventing apparatus, a library information leakage preventing method, and a library information leakage preventing program used in a computer-aided design (i.e., CAD).

### BACKGROUND

In recent years, design methods such as high-speed design and green design have been employed to minimize redesigning and reduce development lead time by utilizing IT tools from the product development stage. IT (CAD) tools such as design tools and analysis tools used by large corporations are similar to one another. However, differences in the quantity and quality of design conditions based on past failures and the physical property values of parts and substrates defined as library information used by the IT (CAD) greatly influence design quality and analysis quality. Such library information is design know-how that belongs to a corporation, and is treated as confidential information for internal use only.

When being engaged in collaborative development such as cooperative design with a competitor company, on the other hand, design data may be exchanged in order to check the whole product. Such an exchange of design data may be done with great caution to prevent the leakage of the company's design know-how defined in library information.

Technology to keep the confidentiality of net-lists, floor-plans, and placement and routing information, which are design data for LSI development, are known in the art (see Japan Laid-open Patent Publication No. 2007-26178, for example).

In a conventional method for evaluating a prototype, the number of items in the library information is small. Because of this, handing the library information to another company may not create a problem. However, library information of nowadays has an increased number of items and includes items relating to confidential design know-how, resulting in a need to prevent the leakage of library information.

FIG. 1 is an illustrative drawing for explaining the import and export of design data. Import is a function to read design data created by another IT (CAD) tool (hereinafter referred to simply as “tool”) and to convert and utilize the design data. Export is a function to output design data in a data format interpretable by another tool. Import and export serve as two-way IF (i.e., interface) with other tools. In FIG. 1, design data is exchanged between a company using a tool A and a company using a tool B as an example of design data exchange between companies.

EDIF (Electronic Design Interchange Format), which is a format (i.e., data format) for design data exchange, is used as an example of a standard IF format in FIG. 1.

The company (i.e., they) using the tool A uses their library information 2 to design a circuit with the tool A. The tool A produces circuit data 1 including symbols, net connections, and the like and EDIF design data 3 created based on their library information 2. The company (i.e., we) using the tool B receives the EDIF design data 3 from their company. Our company uses our library information 5 to edit and add parts (i.e., components) to the circuit with the tool B. The tool B produces circuit data 4 after editing, adding of parts, and the like and EDIF design data 6 created based on our library information 5. Further, their company receives the EDIF design data 6 from our company.

In this manner, the EDIF design data 6 ends up including our library information 5. Our library information 5 includes specific information that is classified as confidential information for internal use only such as design know-how that is not preferably disclosed to their company. Because of this, restriction may be imposed on items of the library information that are output.

FIG. 2 is a drawing illustrating an example of the method for preventing the leakage of library information. As in FIG. 1, their company uses their library information 2 to design a circuit with the tool A. The tool A produces circuit data 1 and EDIF design data 3 created based on their library information 2.

Our company receives the EDIF design data 3 from their company. Our company uses our design-purpose library information 5A to edit and add parts to the circuit with the tool B. The tool B produces circuit data 4 after editing, adding of parts, and the like and EDIF design data 6 created based on our output-purpose library information 5B. Their company receives the EDIF design data 6 from our company.

FIG. 3 is an illustrative drawing illustrating an example of differences between our design-purpose library information and our output-purpose library information. Our design-purpose library information illustrated in FIG. 3 includes “size”, “weight”, “price”, and “lifetime” as items of a part A. Our output-purpose library information illustrated in FIG. 3 includes “weight” as an item of the part A. FIG. 3 provides an example in which the items of the library information that are output as the EDIF design data 6 are limited to the item “weight”.

In the method illustrated in FIG. 2 described above, the management of our library information is twofold, and uses our design-purpose library information 5A and our output-purpose library information 5B. One of our design-purpose library information 5A and our output-purpose library information 5B is selectively used at the time of design and at the time of output. The method illustrated in FIG. 2, however, gives rise to a problem in that the number of management steps increases because both our design-purpose library information 5A and our output-purpose library information 5B are used for twofold management.

In the method illustrated in FIG. 2, further, when their company includes some library information item (e.g., part size) in the EDIF design data 3, our company is supposed to include this item in the EDIF design data 6 that is returned to their company. It may be noted, however, that library information items included in the EDIF design data 3 by their company vary depending on their company's needs.

In the method illustrated in FIG. 2, therefore, library information items included in the EDIF design data 3 by their company may need to be set in our output-purpose library information 5B. This adds to the number of management steps in respect of our output-purpose library information 5B. An increase in the number of management steps heightens the possibility of human error. Human error may lead to the leakage of library information.

### SUMMARY

According to an aspect of the embodiment, An apparatus for preventing library information leakage includes an input processing unit to register, in an input-item list, library information items included in input design data, an input-item-list storing unit to store the input-item list, and an output processing unit to include, in output design data, library information items that match the library information items registered in the input-item list.

According to an aspect of the embodiment, a method of preventing library information leakage performed by a computer includes registering, in an input-item list, library information items included in input design data, and including, in output design data, library information items that match the library information items registered in the input-item list.

According to an aspect of the embodiment, a non-transitory computer-readable medium having a program embodied therein for causing a computer to prevent library information leakage is provided. The program causes the computer to perform registering, in an input-item list, library information items included in input design data, and including, in output design data, library information items that match the library information items registered in the input-item list.

The object and advantages of the embodiment will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is an illustrative drawing for explaining the import and export of design data;

FIG. 2 is a drawing illustrating an example of the method for preventing the leakage of library information;

FIG. 3 is an illustrative drawing illustrating an example of differences between our design-purpose library information and our output-purpose library information;

FIGS. 4A and 4B are drawings illustrating the configurations of a system that performs a library information leakage preventing method of a present embodiment;

FIG. 5 is a drawing showing an example of the hardware configuration of a PC;

FIG. 6 is a drawing illustrating the configurations of a PC that performs the library information leakage preventing method of the present embodiment;

FIG. 7 is a drawing illustrating an example of design data in a standard-IF format;

FIG. 8 is a drawing illustrating an example of EDIF design data received from their company;

FIG. 9 is a drawing illustrating an example of an item correspondence table;

FIG. 10 is a drawing for explaining an example of an input-item list;

FIG. 11 is a drawing for explaining an example of output-enabled-and-output-disabled library item data;

FIG. 12 is an illustrative drawing representing an example of a procedure performed by the system that performs the library information leakage preventing method of the present embodiment;

FIG. 13 is a flowchart illustrating an example of the procedure performed by a data-format conversion unit; and

FIG. 14 is a flowchart illustrating an example of the procedure performed by an inverse data-format conversion unit.

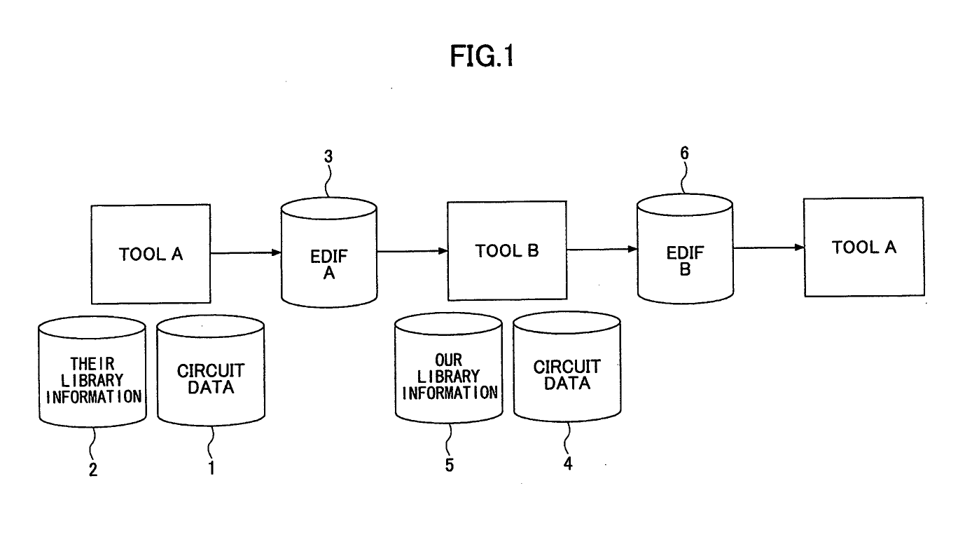

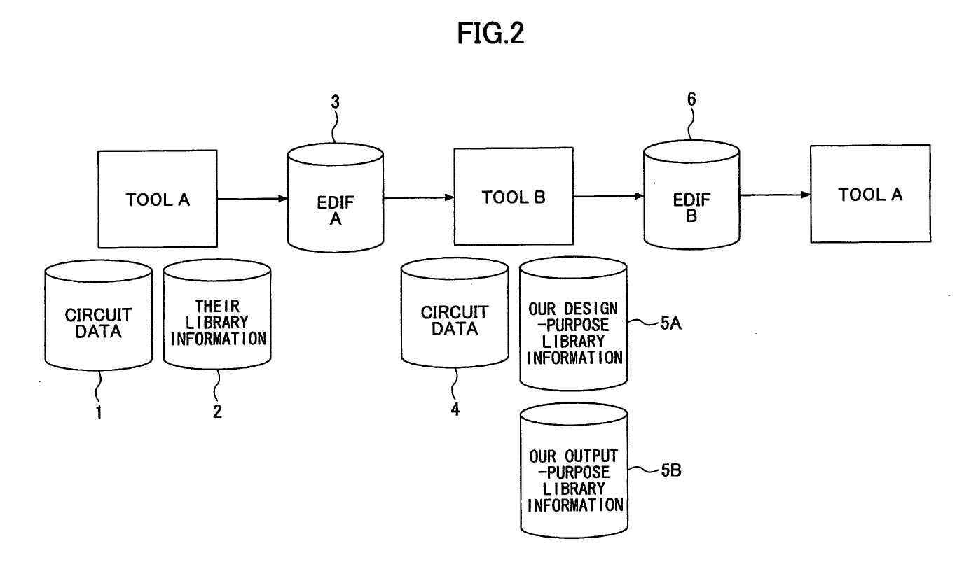

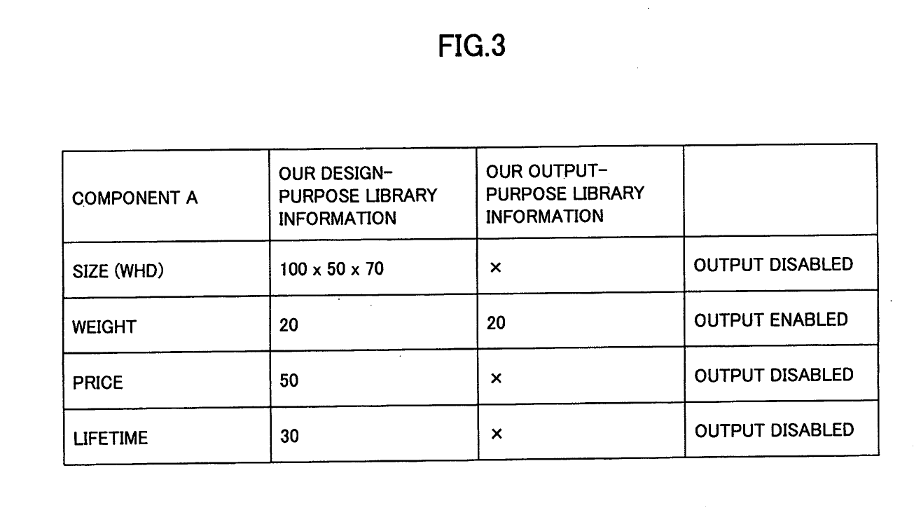

### DESCRIPTION OF EMBODIMENTS

In the following, embodiments will be described by referring to the accompanying drawings. A library information leakage preventing apparatus, a library information leakage preventing method, and a library information leakage preventing program of the present embodiment are examples only, and an apparatus, method, and program having another name may be used.

The library information leakage preventing method of the present embodiment prevents excessive leakage of library information during exchange of design data. In a two-way IF with another tool, the library information leakage preventing method of the present embodiment stores library information items existing upon import, and outputs at the time of export these library information items existing upon import.

Namely, the library information leakage preventing method of the present embodiment achieves the prevention of leakage of library information that is not in existence in the tool used by their company. Design data may be exchanged in the following order: tool A→tool B→tool A. In this case, if the two-way IF of the tool B outputs more library information items than necessary in the design data transferred in the latter-stage exchange: tool B→tool A, specific information that is confidential information for internal use only such as design know-how may leak.

In consideration of this, the library information leakage preventing method of the present embodiment provides a mechanism to store library information items existing upon import and to output, at the time of export, library information items equivalent to these library information items existing upon import.

The library information leakage preventing method of the present embodiment may be implemented as a function of the tool B, or may be implemented as a design data conversion tool that is different from the tool B. When the library information leakage preventing method of the present embodiment is implemented as a design data conversion tool that is separate from the tool B, this design data conversion tool and the tool B may operate on a single personal computer (hereinafter referred to as a PC), or may operate on respective personal computers.

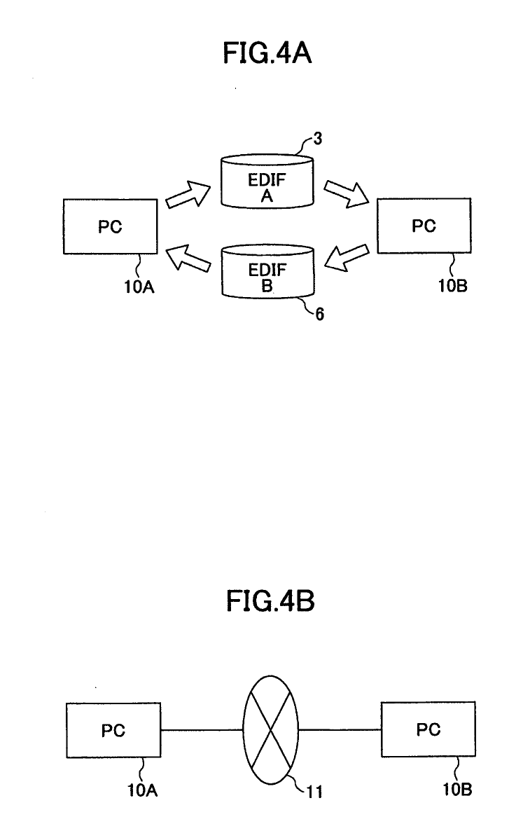

In the following, a description will be given of an example in which the library information leakage preventing method is implemented as a function of the tool B. FIGS. 4A and 4B are drawings illustrating the configurations of a system that performs the library information leakage preventing method of the present embodiment.

FIG. 4A illustrates a configuration in which a PC 10A executing a tool A and a PC 10B executing a tool B are provided. In FIG. 4A, the PC 10A and the PC 10B exchange the EDIF design data 3 and 6 by storing these data in a recording medium such as a CD-ROM, for example.

FIG. 4B illustrates a configuration in which the PC 10A executing the tool A and the PC 10B executing the tool B are connected to each other to perform data communication via a network 11 such as the Internet or a LAN. In FIG. 4B, the PC 10A and the PC 10B exchange the EDIF design data 3 and 6 through the network 11.

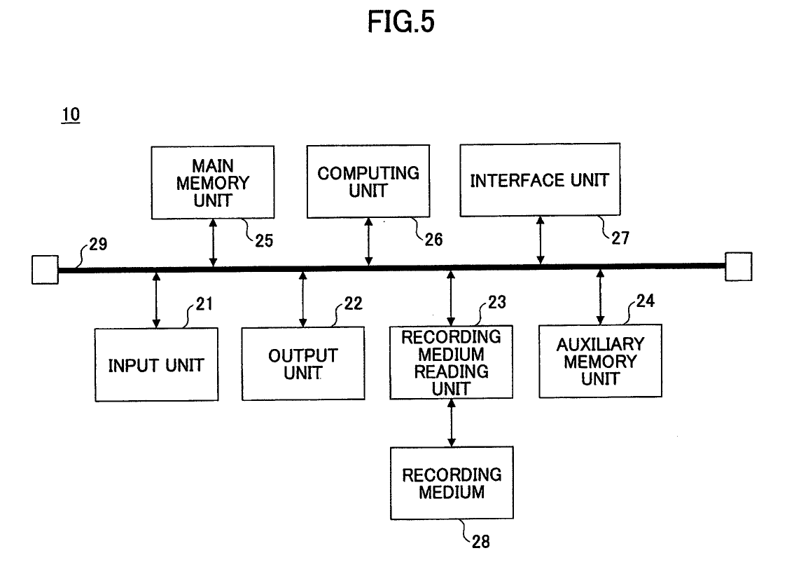

The PC 10A and the PC 10B for executing the tool A and the tool B have a hardware configuration as illustrated in FIG. 5. In the explanation of FIG. 5, the PC 10A and the PC 10B are referred to simple as a PC 10, and the tool A and the tool B are referred to simply as a tool.

FIG. 5 is a drawing illustrating an example of the hardware configuration of a PC. The PC 10 illustrated in FIG. 5 includes an input unit 21, an output unit 22, a recording medium reading unit 23, an auxiliary memory unit 24, a main memory unit 25, a computing unit 26, and an interface unit 27, which are connected together via a bus 29.

The input unit 21 may include a keyboard and mouse. The input unit 21 serves to receive various input signals. The output unit 22 may include a display apparatus. The output unit 22 serves to display various types of windows, data, and the like. The interface unit 27 may include a modem or LAN card, for example. The interface unit 27 serves to provide connection with the network 11.

The library information leakage preventing program of the present embodiment, the tool program, and so on may be at least part of various programs for controlling the PC 10 illustrated in FIG. 5. The programs may be provided through the delivery of a recording medium 28 or through downloading via the network 11. The recording medium 28 having the programs recorded therein can be any type of recording medium. That is, it may be a recording medium for recording information by use of an optical, electrical, or magnetic means such as a CD-ROM, a flexible disk, or a magneto-optical disk, or may be a semiconductor memory for recording information by use of an electrical means such as a ROM or a flash memory.

Upon setting the record medium 28 containing the programs to the recording medium reading unit 23, the programs are installed from the record medium 28 to the auxiliary memory unit 24 through the recording medium reading unit 23. The programs that are downloaded through the network 11 are installed to the auxiliary memory unit 24 through the interface unit 27. The auxiliary memory unit 24 stores the installed programs, and, also, stores various files and data.

At the time of execution, the programs are read from the auxiliary memory unit 24 to be loaded to the main memory unit 25. The computing unit 26 performs various types of processing according to the programs stored in the main memory unit 25 as will be describe later. The PC 10 that executes the library information leakage preventing program is an example of the library information leakage preventing apparatus.

### <Block Configuration>

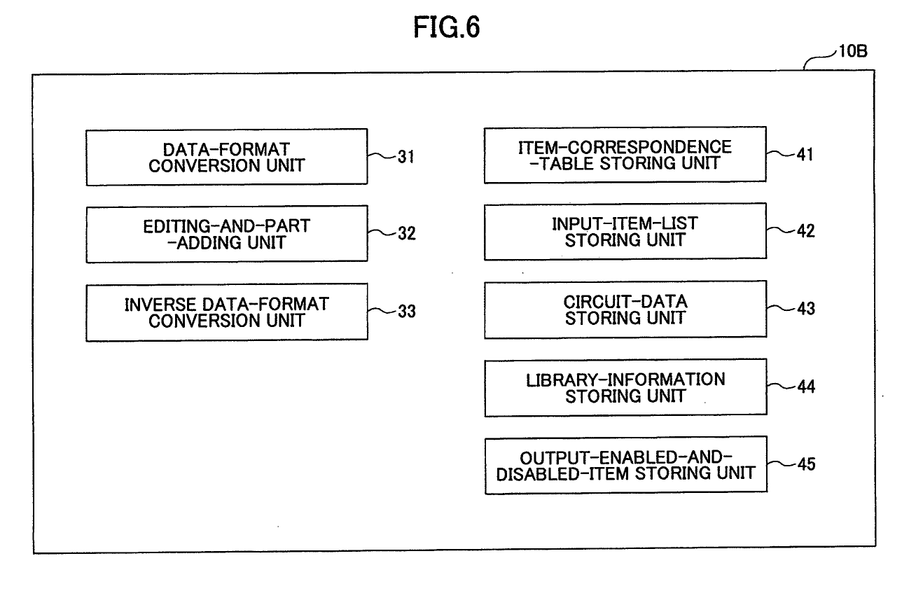

The PC 10B, for example, performs various types of processing according to the programs stored in the main memory unit 25 as illustrated in FIG. 6. FIG. 6 is a drawing illustrating the configurations of a PC that performs the library information leakage preventing method of the present embodiment.

The PC 10B illustrated in FIG. 6 includes a data-format conversion unit 31, an editing-and-part-adding unit 32, an inverse data-format conversion unit 33, an item-correspondence-table storing unit 41, an input-item-list storing unit 42, a circuit-data storing unit 43, a library-information storing unit 44, and an output-enabled-and-disabled-item storing unit 45.

The data-format conversion unit 31 receives the EDIF design data 3 output by the tool A, and converts the received EDIF design data 3 into the data format of the tool B. In so doing, the data-format conversion unit 31 utilizes an item correspondence table in which library information items of the tool A are associated with library information items of the tool B in advance. Further, the data-format conversion unit 31 stores an input-item list which lists tool-A part library names and library information item names (i.e., property names) retrieved from the EDIF design data 3 output by the tool A.

The editing-and-part-adding unit 32 utilizes our library information 5 to perform design and check such as editing and part-adding with respect to the circuit of the design data that is converted into the tool-B data format. The editing-and-part-adding unit 32 causes the circuit data 4 to reflect the addition and removal of parts resulting from designing such as editing and part-adding with respect to the circuit.

The inverse data-format conversion unit 33 converts the EDIF design data 6 into the data format of the tool A based on our library information 5 and the circuit data 4 obtained after editing, adding of parts, and the like performed by the editing-and-part-adding unit 32. In so doing, the inverse data-format conversion unit 33 selects and outputs library information items equivalent to those of the received EDIF design data 3 according to the input-item list. Further, the inverse data-format conversion unit 33 utilizes the output-enabled-and-disabled library item data that controls an output-enabled or output-disabled state of library information items of the tool B, thereby also controlling an output-enabled or output-disabled state of library information items of the added parts and the library information items that are never to be output.

The item-correspondence-table storing unit 41 stores data of the item correspondence table. The input-item-list storing unit 42 stores data of the input-item list. The circuit-data storing unit 43 stores the circuit data 4. The library-information storing unit 44 stores our library information 5. The output-enabled-and-disabled-item storing unit 45 stores data of the output-enabled-and-output-disabled library items.

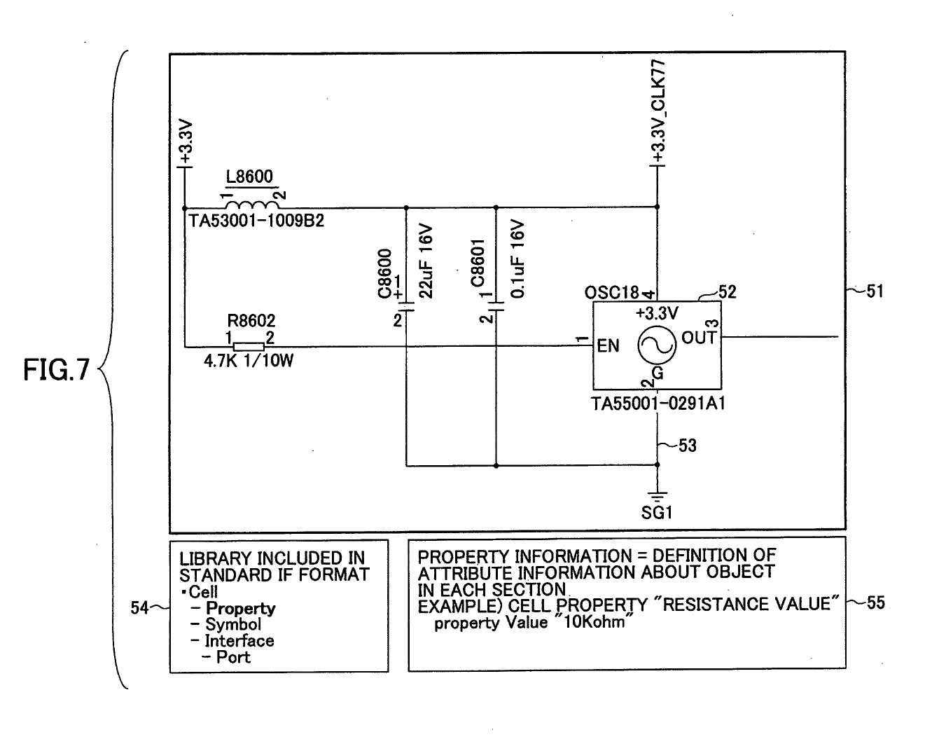

FIG. 7 is a drawing illustrating an example of design data in the standard-IF format. A circuit diagram 51 providing a visual representation of the circuit data 1 is associated with library information 54 defined for each circuit element such as an instance 52 and a net 53. In FIG. 7, “Cell” indicates the library information 54. The library information 54 passes various types of information via “Property”.

In FIG. 7, “Property” indicates the property information 55. The property information 55 defines attribute information of an object in the “Cell” section The property information 55 of the library information 54 illustrated in FIG. 7 specifies the property name “Value” and the value “10 Kohm”. A plurality of pieces of property information 55 may be defined for the library information 54. The property information 55 is an example of an item of the library information 54.

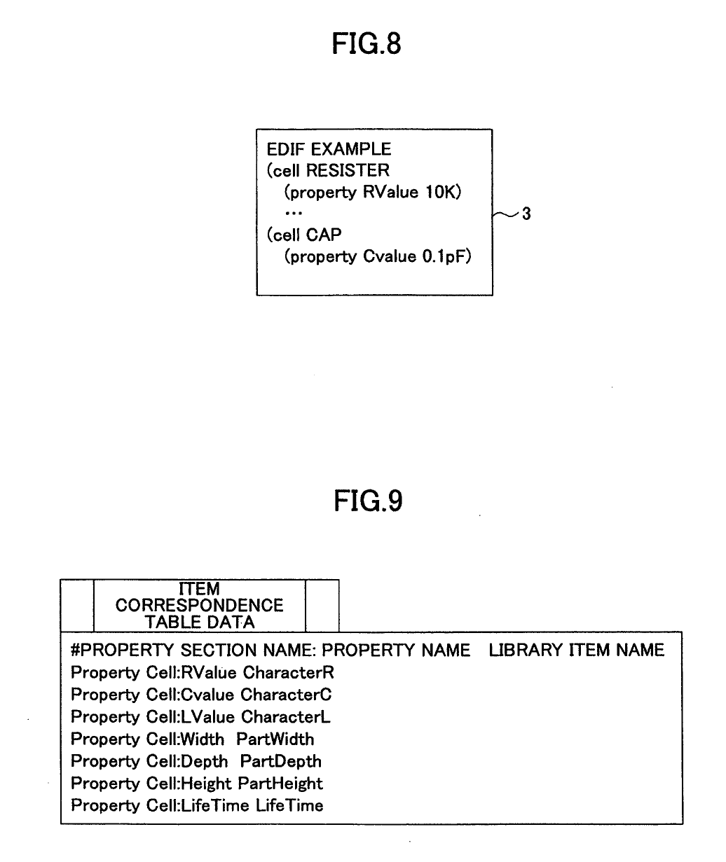

FIG. 8 is a drawing illustrating an example of EDIF design data received from their company. The EDIF design data 3 illustrated in FIG. 8 specifies property information inclusive of the property name “RValue” and the value “10 K” and property information inclusive of the property name “Cvalue” and the value “0.1 pF”.

FIG. 9 is a drawing illustrating an example of the item correspondence table. The item correspondence table illustrated in FIG. 9 includes library information items (i.e., property information) of the tool A and library information items of the tool B associated therewith. Specifically, in the item correspondence table illustrated in FIG. 9, the tool-A library information items are provided as “section name: property name” in the EDIF design data 3, and are associated with library item names which are the tool-B library information items.

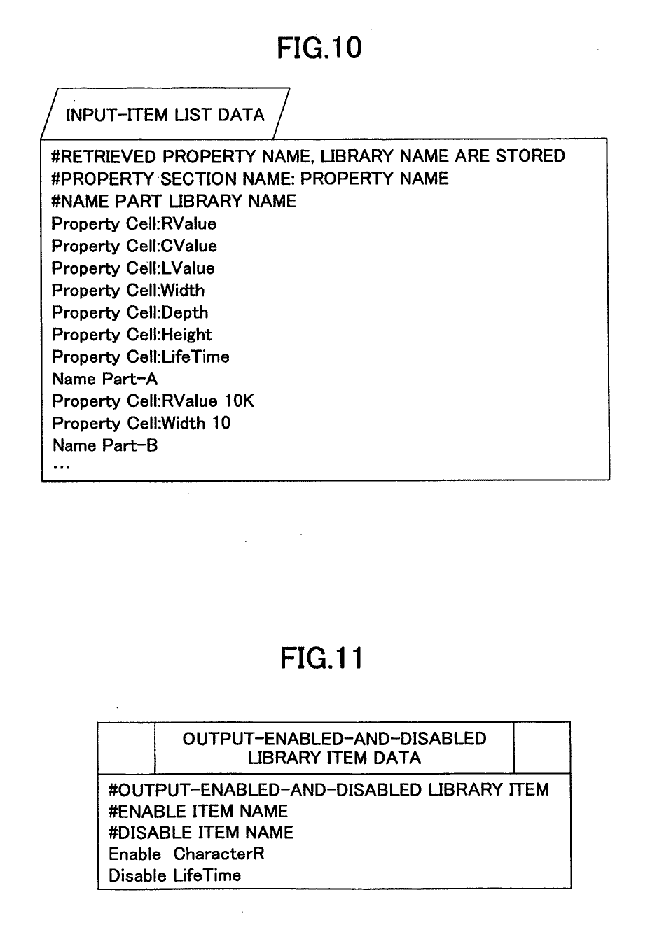

FIG. 10 is a drawing for explaining an example of the input-item list. The input-item list illustrated in FIG. 10 includes property names and library names retrieved from the EDIF design data 3 output by the tool A. In the input-item list, a “section name: property name” entry of the EDIF design data 3 is associated with a part library name. Namely, the input-item list illustrated in FIG. 10 stores therein property names and part library names retrieved from the EDIF design data 3. The input-item list illustrated in FIG. 10 stores therein one or more sets of a property name and a value for each part library name (which is provided on a part-specific basis).

FIG. 11 is a drawing for explaining an example of the output-enabled-and-output-disabled library item data. The output-enabled-and-output-disabled library item data controls an output-enabled or output-disabled state of a library information item of the tool B on a library-item-specific basis. In an example illustrated in FIG. 11, the tool-B library item name “CharacterR” is indicated as an output-enabled library item. In FIG. 11, further, the tool-B library item name “LifeTime” is indicated as an output-disabled library item. Although an output-enabled or output-disabled state of a tool-B library information item is specified by an output-enabled or output-disabled indication on a library-item-specific basis in FIG. 11, such a state may be specified by use of a property name appearing in the item correspondence table.

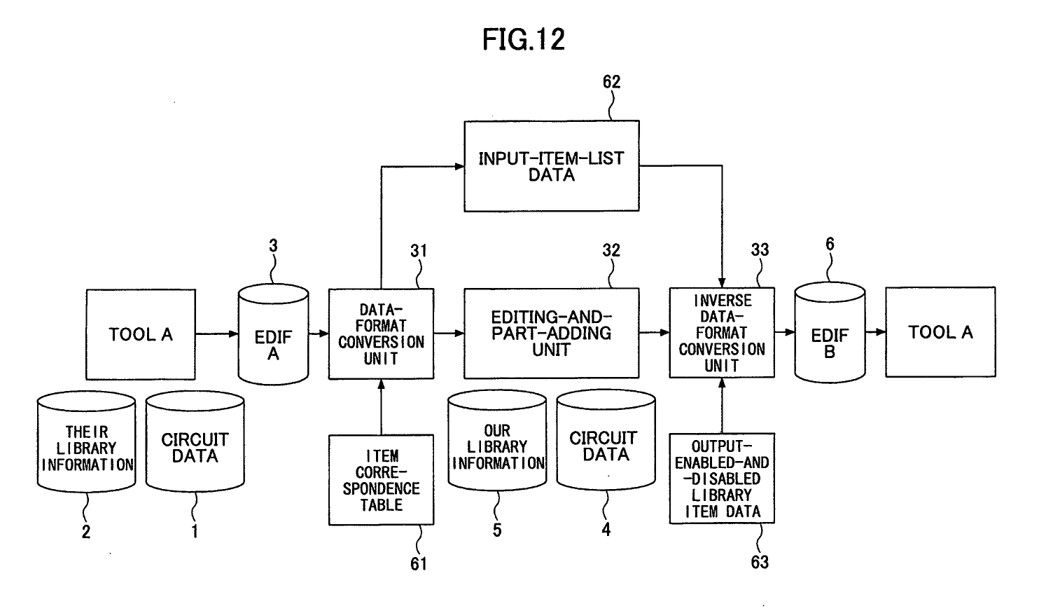

FIG. 12 is an illustrative drawing representing an example of a procedure performed by the system that performs the library information leakage preventing method of the present embodiment. Their company that employs the tool A produces the circuit data 1 and the EDIF design data 3 created based on their library information 2. Subsequent processes are performed by our company that employs the tool B.

The data-format conversion unit 31 receives the EDIF design data 3, and converts the received EDIF design data 3 into the data format of the tool B. In so doing, the data-format conversion unit 31 utilizes an item correspondence table 61. Further, the data-format conversion unit 31 stores property names and part library names retrieved from the EDIF design data 3 as input-item-list data 62.

The editing-and-part-adding unit 32 utilizes our library information 5 to perform editing, part-adding, and so on to design and check the circuit of the design data that is converted into the tool-B data format. The editing-and-part-adding unit 32 incorporates into the circuit data 4 the addition and removal of parts resulting from circuit designing such as editing and part-adding.

The inverse data-format conversion unit 33 outputs the EDIF design data 6 converted into the tool-A data format based on our library information 5 and the circuit data 4 obtained after editing, adding of parts, and so on performed by the editing-and-part-adding unit 32. In so doing, the inverse data-format conversion unit 33 selects and outputs library information items equivalent to those of the received EDIF design data 3 according to the input-item-list data 62. Further, the inverse data-format conversion unit 33 utilizes output-enabled-and-disabled library item data 63 to control an output-enabled or output-disabled state of library information items of the added parts and the library information items that are never to be output.

Subsequent processes are performed by their company that employs the tool A. Their company employing the tool A receives the EDIF design data 6 converted into the tool-A data format from our company that employs the tool B.

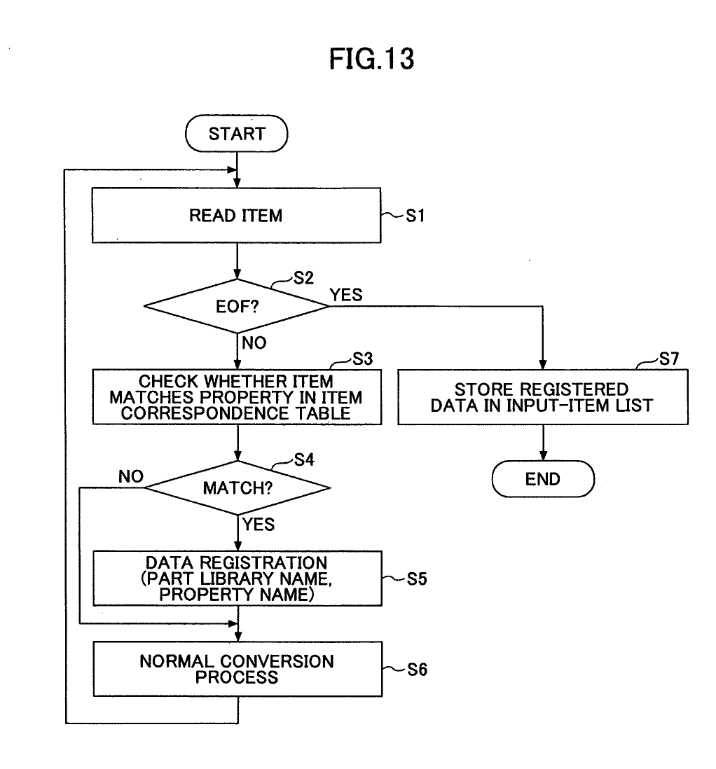

FIG. 13 is a flowchart illustrating an example of the procedure performed by the data-format conversion unit. Upon receiving the EDIF design data 3 as illustrated in FIG. 8, for example, the data-format conversion unit 31 reads, in step S1, one item from the EDIF design data 3 output by the tool A. In step S2, the data-format conversion unit 31 checks whether the item read in step S1 is an EOF (End Of File).

In the case of the item being not an EOF, the data-format conversion unit 31 checks in step S3 whether the name (i.e., property name) of the library information item read in step S1 matches a property name in the item correspondence table 61.

Upon detecting a match in step S4, the data-format conversion unit 31 temporarily stores the part library name and property name read in step S1 as registered data in the input-item-list data 62. The procedure then proceeds to step S6. Upon finding no match in step S4, the data-format conversion unit 31 skips the process in step S5 to proceed directly from step S4 to step S6.

In step S6, the data-format conversion unit 31 performs normal conversion for converting the tool-A data format into the tool-B data format, thereby producing design data in the tool-B data format. The normal conversion performed in step S6 is known in the art, and a detailed description thereof will be omitted.

Upon detecting an EOF in step S2, the data-format conversion unit 31 stores the temporarily stored registered data in the input-item-list data 62 in step S7. With this, the procedure of FIG. 13 comes to an end.

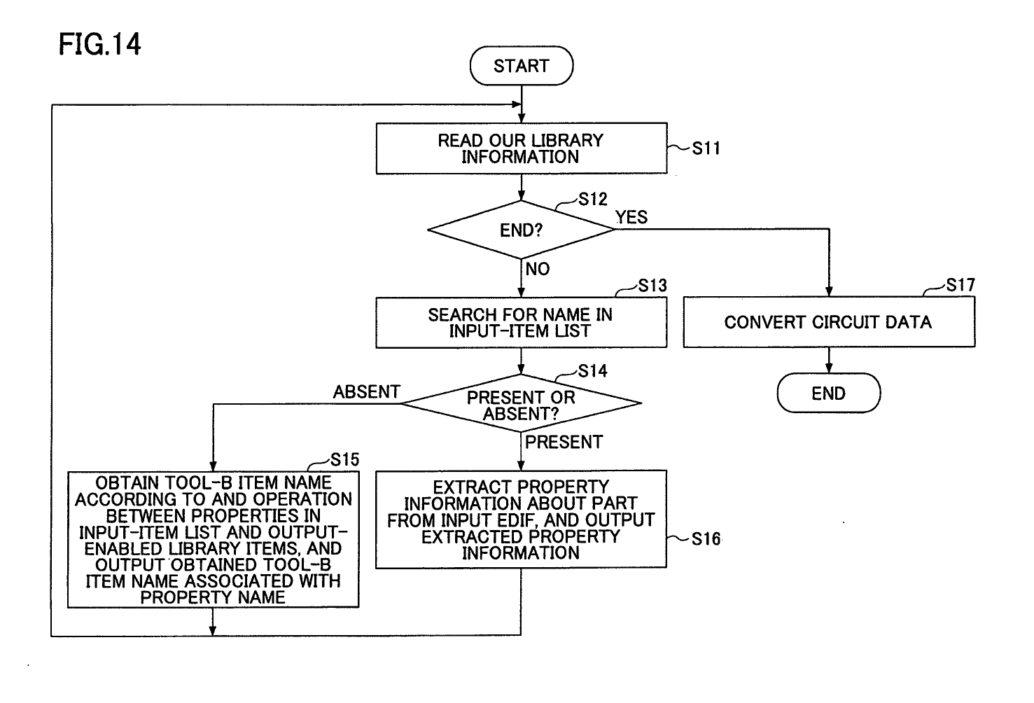

FIG. 14 is a flowchart illustrating an example of the procedure performed by the inverse data-format conversion unit. In step S11, the inverse data-format conversion unit 33 reads one part library name from our library information 5. In step S12, the inverse data-format conversion unit 33 checks whether a part library name can be read in step S11, i.e., whether the reading of part library names from our library information 5 has been completed.

Upon successfully reading a part library name in step S11, i.e., in the event that the reading of part library names from our library information 5 has not been completed, the inverse data-format conversion unit 33 proceeds to step S13 to search for a matching part library name “Name” in the input-item-list data 62 by use of the part library name read in step S11.

Namely, the process in step S13 checks whether the library information of the part library name read in step S11 is library information of a part added by the editing-and-part-adding unit 32. The part library name read in step S11 may not be registered as a part library name “Name” in the input-item-list data 62. In such a case, it is ascertained that the library information of the part library name read in step S11 is library information of a part added by the editing-and-part-adding unit 32.

Upon detecting in step S14 that the part library name read in step S11 is not registered as a part library name “Name” in the input-item-list data 62, the inverse data-format conversion unit 33 proceeds to step S15. In step S15, the inverse data-format conversion unit 33 obtains tool-B library information items to be output according to an AND (i.e., logic product) operation between the property names in the input-item-list data 62 and the output-enabled library item names in the output-enabled-and-disabled library item data 63, thereby outputting the obtained items in such a manner that they are associated with property names.

Upon detecting in step S14 that the part library name read in step S11 is registered as a part library name “Name” in the input-item-list data 62, the inverse data-format conversion unit 33 proceeds to step S16. If the part library name read in step S11 is registered as a part library name “Name” in the input-item-list data 62, it is ascertained that the library information of the part library name read in step S11 is library information of a part originally included in the EDIF design data 3.

The inverse data-format conversion unit 33 extracts property information about the part from the EDIF design data 3 to output the extracted information. If it is ascertained in step S12 that a part library name cannot be read in step S11, i.e., that the reading of part library names from our library information 5 has been completed, the inverse data-format conversion unit 33 proceeds to step S17, in which a circuit data conversion process is performed to convert the tool-B data format to the tool-A data format. As a result, the design data in the tool-A data format is obtained. The circuit data conversion process performed in step S17 is known in the art, and a detailed description thereof will be omitted.

In the flowchart of FIG. 14, step S15 is performed with respect to the parts that are added by the tool B. The inverse data-format conversion unit 33 selects library information items to be included in the EDIF design data 6 from the library information items of the parts added by the tool B by referring to the library information items of other parts retrieved from the EDIF design data 3 and the items listed in the output-enabled-and-disabled library item data. Step S16 is performed to output library information items that are identical in all aspects including values to the library information items of the parts retrieved from the EDIF design data 3.

It suffices for the library information leakage preventing method of the present embodiment to manage and control only our library information 5. The number of management steps (performed for editing and checking) can thus be reduced. With respect to parts that have been neither edited nor added, the library information leakage preventing method of the present embodiment automatically outputs the same library information items that are originally in existence in the received design data. With respect to parts that have been added, the library information leakage preventing method of the present embodiment does not output more library information items than necessary by utilizing the output-enabled-and-disabled-state control information and the library information items that are originally in existence in the received design data.

Although the present embodiment has been described with reference to an example in which the tool A is different from the tool B, the above-noted advantages are obtained even if these tools are identical to each other.

According to at least one embodiment, excessive leakage of library information used in computer-aided design is easily prevented.

Elements of at least one disclosed embodiment or any combination of these elements may be applied to a method, an apparatus, a computer program, a recording medium, a data structure, or the like to provide another viable embodiment.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. An apparatus for preventing library information leakage, comprising:
an input processing unit to register, in an input-item list, library information items included in input design data;
an input-item-list storing unit to store the input-item list; and
an output processing unit to include, in output design data, library information items that match the library information items registered in the input-item list.

2. The apparatus as claimed in claim 1, further comprising an output-control-data storing unit to store output-control data for controlling an output-enabled and output-disabled state of a library information item, wherein the output processing unit includes, in the output design data, library information items indicated as being output-enabled by the output-control data, and avoids including, in the output design data, library information items indicated as being output-disabled by the output-control data.

3. The apparatus as claimed in claim 2, wherein the input processing unit to register, in the input-item list, part library names included in the input design data in addition to the library information items included in the input design data, and wherein the output processing unit obtains a name of a part library not included in the input design data by using the part library names registered in the input-item list, and includes one or more library information items of the part library in the output design data such that the one or more library information items of the part library match the library information items registered in the input-item list, and also match the library information items indicated as being output-enabled by the output-control data.

4. The apparatus as claimed in claim 3, wherein a name of a part library included in the input design data is obtained by using the part library names registered in the input-item list, and one or more library items and values thereof of the part library included in the input design data are retrieved from the input design data for inclusion in the output design data.

5. A method of preventing library information leakage performed by a computer, comprising:
registering, in an input-item list, library information items included in input design data; and
including, in output design data, library information items that match the library information items registered in the input-item list.

6. A non-transitory computer-readable medium having a program embodied therein for causing a computer to prevent library information leakage, the program causing the computer to perform:
registering, in an input-item list, library information items included in input design data; and
including, in output design data, library information items that match the library information items registered in the input-item list.
